(19) United States
(12) Patent Application Publication
(10) Pub. No.: US 2023/0384214 A1
(43) Pub. Date: Nov. 30, 2023

(54) Apparatus and method for jointly detecting a color and a distance of an object

(71) Applicant: SICK AG, Waldkirch (DE)

(72) Inventors: Roland ALBRECHT, Emmendingen (DE); Johannes EBLE, Waldkirch (DE); Wendelin FISCHER, Freiburg (DE); Günter HIRT, Steinach (DE); Eva-Maria KRIENER, Freiburg (DE); Ralf MEYER, Wyhl am Kaiserstuhl (DE); Matthias OPFOLTER, Denzlingen (DE); Hans-Peter REICHENBACH, Glottertal (DE)

(21) Appl. No.: 18/200,732

(22) Filed: May 23, 2023

(30) Foreign Application Priority Data
May 24, 2022 (EP) 22175219.9

(51) Int. Cl. G01N 21/25; G01S 7/48; G01S 17/32

(52) U.S. Cl. CPC G01N 21/255; G01S 7/4808; G01S 17/32

(57) ABSTRACT

An apparatus comprising a transmission unit comprising a light element that is configured to emit light in a predefined wavelength range; and a transmission optics that is configured to direct the emitted light to an object; a reception unit comprising a first reception element; a second reception element that is arranged spaced apart from the first reception element; and a reception optics that is configured to receive light remitted by the object and to direct it to the first reception element and the second reception element; and an evaluation unit that is configured to evaluate light received by the first reception element and to determine a distance of the object and to evaluate light received by the second reception element and to determine a color of the object.

The invention relates to an apparatus and a method for jointly detecting a color and a distance of an object.

Apparatus and methods that are configured to recognize a color or a distance of an object are known in principle. In particular when determining a color, it is desirable to also know the distance of the object since the determined color values change in dependence on the distance of the object and thus the color resolution also changes.

It is therefore an object to disclose an improved apparatus and an improved method for jointly detecting a color and a distance of an object.

This object is first satisfied by an apparatus comprising a transmission unit; a reception unit; and an evaluation unit. The transmission unit in this respect comprises a light element that is configured to emit light in a predefined wavelength range; and a transmission optics that is configured to direct the emitted light to an object. The reception unit comprises a first reception element; a second reception element that is arranged spaced apart from the first reception element; and a reception optics that is configured to receive light remitted by the object and to direct it to the first reception element and the second reception element. The evaluation unit is configured to evaluate light received by the first reception element and to determine a distance of the object and to evaluate light received by the second reception element and to determine a color of the object.

The light element is in this respect configured to emit light in a predefined wavelength range, in particular in the range of visible light. In this respect, the light element is in particular configured to emit chromatically broadband light, so-called white light.

The transmission optics directs the emitted light to an object whose color is to be recognized. One or more lenses and/or one or more mirrors can be used for this purpose.

The light is remitted by the object and is directed to a first and a second reception element by means of the reception optics that can likewise have one or more lenses and/or one or more mirrors. The first reception element is in this respect configured to return distance information and is, for example, configured as a line sensor. Alternatively, the first reception element can also be configured as a time-of-flight sensor. The second reception element is configured to return color information and is, for example, configured as a color sensor. The second reception element is in particular configured to detect different color components in the light remitted by the object, for example, by a so-called CCD sensor.

The evaluation unit then evaluates the information received from the first and second reception elements and thus determines a distance and a color.

In this respect, a single light element is in particular used to emit light that is used both for the distance detection and for the color detection. A particularly compact and favorable design of the apparatus hereby results.

One embodiment of the apparatus provides that the light element has a first light source, a second light source, and a third light source that are spaced apart from one another and that are configured to emit light in three different predefined wavelength ranges, wherein the transmission unit further has a superposition optics that is configured to superpose the light emitted by the three light sources and to direct it to a common beam axis.

The first, second, and third light source are in particular configured as semiconductor light sources, in particular light-emitting diodes. In this respect, the first, second, and third wavelength ranges in particular lie in the spectrum of visible light. The three wavelength ranges are in particular in the red, green, and blue range. The three wavelength ranges differ in this respect, but can partly overlap. This is in particular an alternative embodiment to the embodiment described further above in which the light element comprises a single light source that is configured to emit chromatically broadband light, so-called white light.

In this embodiment, the first, second, and third light source can in particular be activated after one another so that a specific emission pattern results from the three wavelength ranges. In this case, the second reception element can be configured such that it can determine, in particular only, the intensity of the remitted light and the evaluation unit determines the color of the object on the basis of this intensity, in particular taking into account the emission pattern.

A particularly good color recognition is made possible by this embodiment.

One embodiment of the apparatus provides that the superposition optics comprises a reflector that has a plurality of reflective surfaces that are arranged and configured to superpose the light emitted by the three light sources and to direct it to a common beam axis.

This embodiment of the superposition optics is, for example, described in EP 3 770 567 B1.

An alternative embodiment of the apparatus provides that the superposition optics has two dichroic mirrors that are arranged and configured to superpose the light emitted by the three light sources and to direct it to a common beam axis.

This embodiment of the superposition optics can also be designated as a beam splitter staircase.

A further alternative embodiment of the apparatus provides that the superposition optics comprises a first prism, a second prism, a third prism, and a fourth prism that are arranged adjacent to one another such that they together have a cuboid shape, wherein contact surfaces between the prisms are dichroically coated.

This embodiment in particular provides that the first, second, third, and fourth prisms are cemented and/or glued together, in particular at respective surfaces that extend from one of the legs of the triangle underlying a prism.

A particularly good superposition of the light emitted by the three light sources is made possible by these three alternative embodiments.

One embodiment of the apparatus provides that the apparatus further comprises a sectionally flexible base element at which the first light source, the second light source, and the third light source are arranged, wherein the base element is arranged around the superposition optics such that one light source each is arranged at one of three adjacent side surfaces of the superposition optics.

Due to this embodiment, a particularly simple assembly of the first, second, and third light sources is possible.

One embodiment of the apparatus provides that the base element has a first positioning element, a second positioning element, and a third positioning element that fasten the first light source, the second light source, and the third light source at a predefined distance from the three adjacent side surfaces of the superposition optics. The first, second, and third positioning elements in particular fasten the first, second, and third light sources in a width, a length, and a height in each case, i.e. in x, y, and z in space, with respect to the three adjacent side surfaces of the superposition optics.

Optionally, the first light source, the second light source, and the third light source have an aperture, wherein the predefined distance is in particular a direct contact, further in particular a gap-free contact of the respective aperture with the respective side surface of the superposition optics. Alternatively or additionally, a respective aperture can be provided between the positioning element and the respective side surface.

A particularly precise positioning of the light sources with respect to the superposition optics is ensured by this embodiment.

One embodiment of the apparatus provides that the base element further has a fourth positioning element, and wherein the first positioning element, the second positioning element, the third positioning element, and the fourth positioning element fasten the superposition optics to four adjacent side surfaces.

A particularly secure fastening of the superposition optics is made possible by this embodiment.

One embodiment of the apparatus provides that the fourth positioning element has an aperture that is configured to spatially limit the light superposed by the superposition optics.

A setting of the size and shape of the light spot on the object is made possible by this embodiment.

One embodiment of the apparatus provides that the fourth positioning element fastens the aperture at a predefined distance from the fourth side surface. The fourth positioning element in particular fastens the aperture in a width, a length, and a height, i.e. in x, y, and z in space, with respect to the fourth side surfaces of the superposition optics.

The predefined distance is in particular a direct contact, further in particular a gap-free contact.

A particularly precise superposition is made possible by this embodiment.

One embodiment of the apparatus provides that the first positioning element, the second positioning element, and the third positioning element each comprise an upper and a lower holding element that are configured to fasten the superposition optics to an upper surface and a lower surface. With the aid of these holding elements, the positioning of the first, second, and third light sources relative to the superposition optics and/or the respective aperture can in particular be ensured.

A particularly secure fastening of the superposition optics is ensured by this embodiment.

One embodiment of the apparatus provides that the evaluation unit is configured to correct the determined color based on the determined distance of the object.

For this purpose, the distance from the object is determined regularly, for example at 1 kHz, whereby a high-frequency compensation of the color values is made possible. The correction of the determined color in particular takes place based on a function that is stored in the evaluation unit and that is individually stored during the production for each color and matching the second reception element. The evaluation unit, for example, determines the distance of the object by means of triangulation based on the light spot position on the line sensor and, from this, determines compensation or correction factors for the color determined by the second reception element. This correction factor is multiplied accordingly by the signals of the second reception element to compensate the object distance in the height of the measurement signal.

On the detection of a color by the second reception element at different distances, the detected measurement signal can change by several orders of magnitude. Since the resolvability of color differences is primarily dependent on the difference of the detected measurement signal, the resolvability of color differences also changes with different object distances. To keep the color resolution as optimal as possible over the entire working zone, the electrical gain of the measurement signal of the second reception element is dynamically set depending on the height of the measurement signal and thus also on the distance of the object. Accordingly, the electrical gain is increased for large distances and low signal heights and decreased for small distances and intense signals.

The color resolution set in the evaluation unit and usable for the application is adapted in accordance with the set electrical gain and the determined distance correction factor. It can thus be adjusted in dependence on the application conditions.

A particularly precise color determination is made possible by this embodiment.

One embodiment of the invention provides that the reception optics is formed in one piece. In the present case, in one piece means made of a contiguous material and can also be referred to as integral.

A particularly compact design of the apparatus is made possible by this embodiment.

The initially mentioned object is also satisfied by a method for jointly detecting a color and a distance of an object.

In this respect, the method comprises emitting light in a predefined wavelength range; directing the emitted light to an object; receiving light remitted by the object; directing the remitted light to a first reception element and a second reception element; evaluating the light received by the first reception element to determine a distance of the object; and evaluating the light received by the second reception element to determine a color of the object.

With respect to the embodiments and advantages of the method for jointly detecting a color and a distance of an object, reference is made to the embodiments and advantages of the apparatus for jointly detecting a color and a distance of an object.

An apparatus for fastening a superposition optics is likewise provided in accordance with the invention. The apparatus comprises a sectionally flexible base element, and a first, second, and third positioning element that are arranged at the flexible base element, wherein the sectionally flexible base element is bendable such that the first positioning element can be brought into engagement with the second positioning element and the second positioning element can be brought into engagement with the third positioning element and can thus form a hollow space in which a superposition optics can be arranged. The apparatus also comprises a fourth positioning element that can be brought into engagement with the first and third positioning elements and thus fastens the superposition optics to the apparatus.

With respect to the embodiments and advantages of the apparatus for fastening a superposition optics, reference is made to the embodiments and advantages of the apparatus for jointly detecting a color and a distance of an object.

A method for fastening a superposition optics is also provided in accordance with the invention. In this respect, the method comprises the steps providing an apparatus for fastening a superposition optics comprising a sectionally flexible base element and a first, second, and third positioning element arranged thereat; bending the sectionally flexible base element; bringing the first positioning element into engagement with the second positioning element; bringing the second positioning element into engagement with the third positioning element; arranging a superposition optics within a hollow space that is formed by the engagement of the first, second, and third positioning elements; bringing a fourth positioning element into engagement with the first and third positioning elements; and thus fastening the superposition optics.

With respect to the embodiments and advantages of the method for fastening a superposition optics, reference is made to the embodiments and advantages of the apparatus for fastening a superposition optics.

Embodiments of the apparatus and the method for jointly detecting a color and a distance of an object and of the apparatus and the method for fastening a superposition optics are now described in more detail in connection with the following Figures. There are shown:

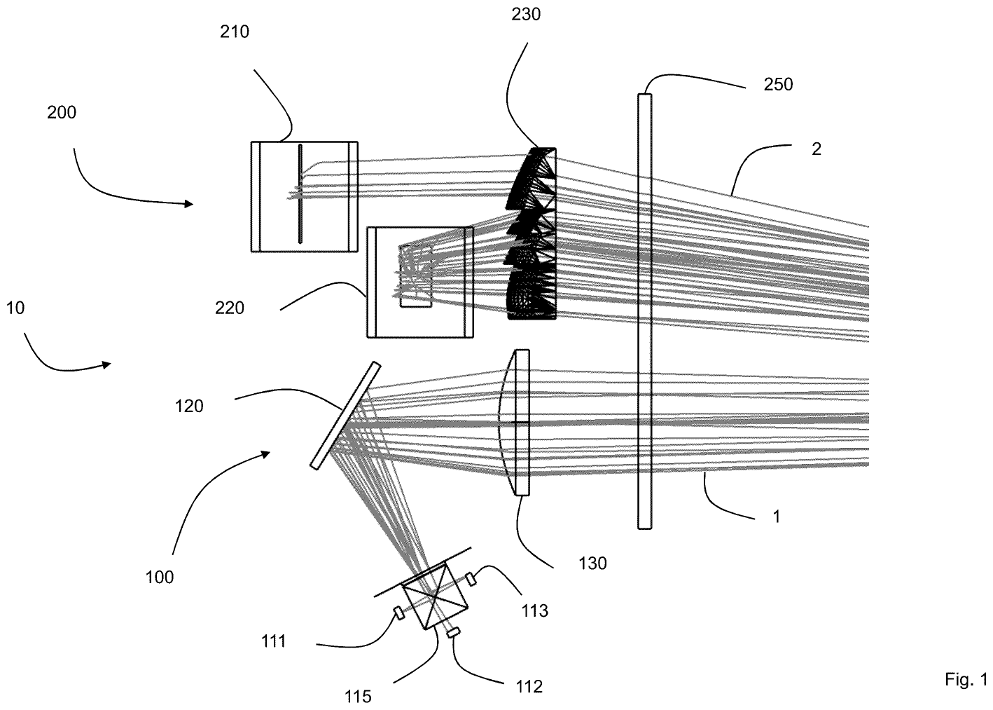

FIG. 1 a schematic plan view of an apparatus for jointly detecting a color and a distance of an object;

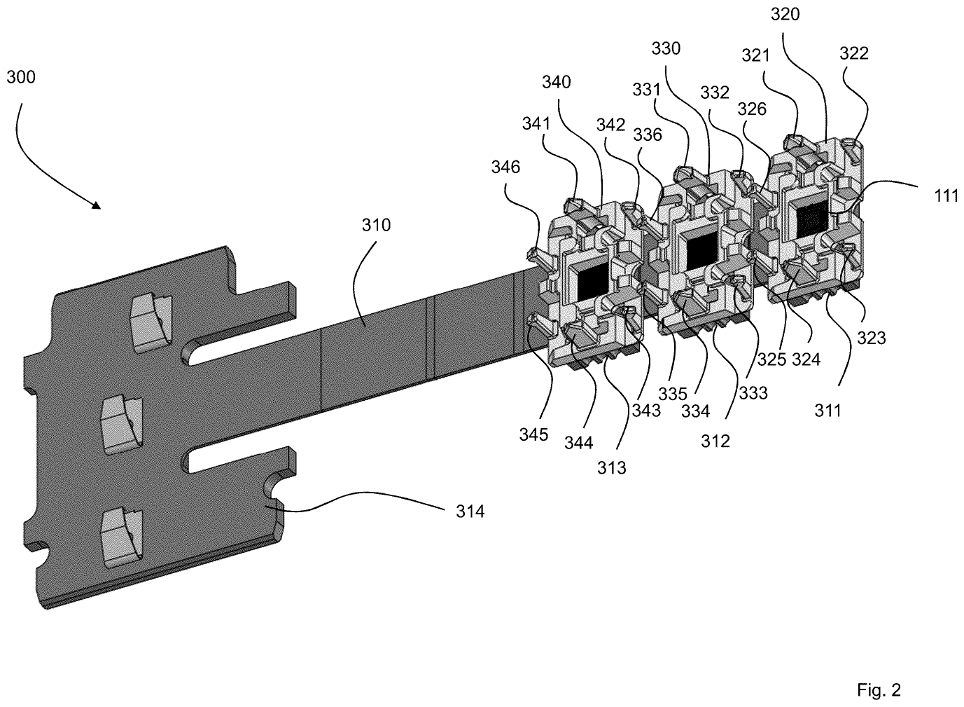

FIG. 2 a perspective view of an apparatus for fastening a superposition optics;

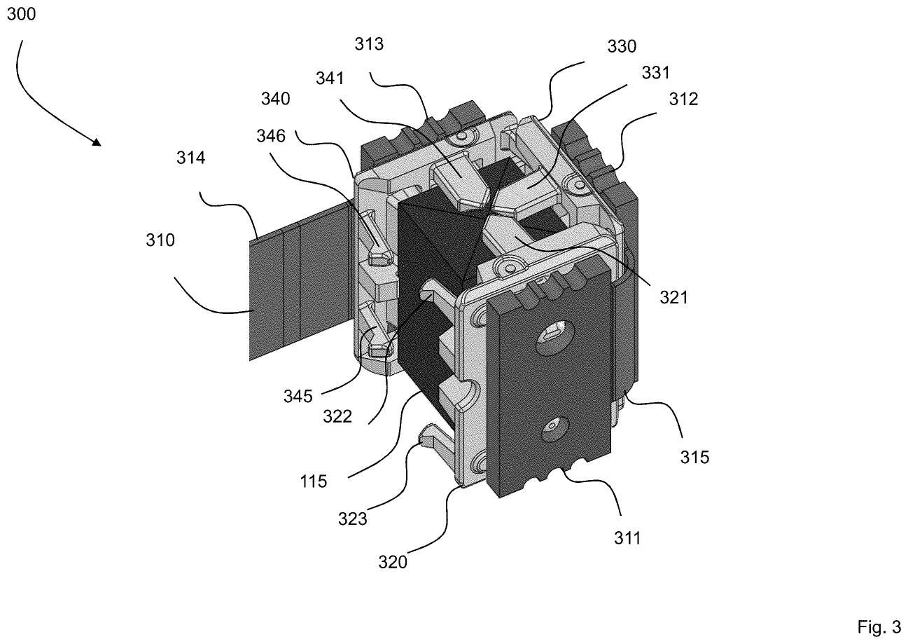

FIG. 3 a perspective view of an apparatus from FIG. 2;

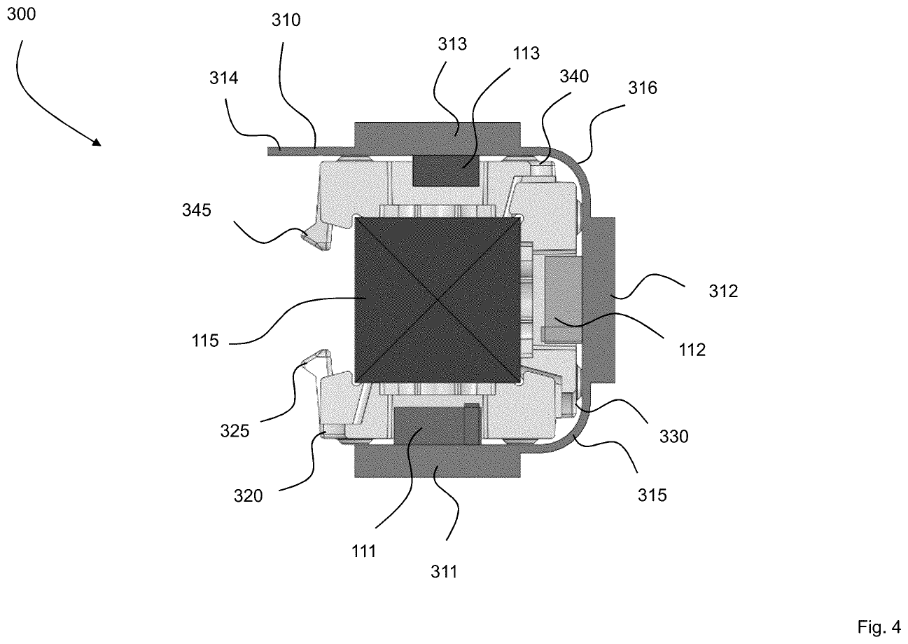

FIG. 4 a plan view of the apparatus shown in FIG. 3 in cross-section;

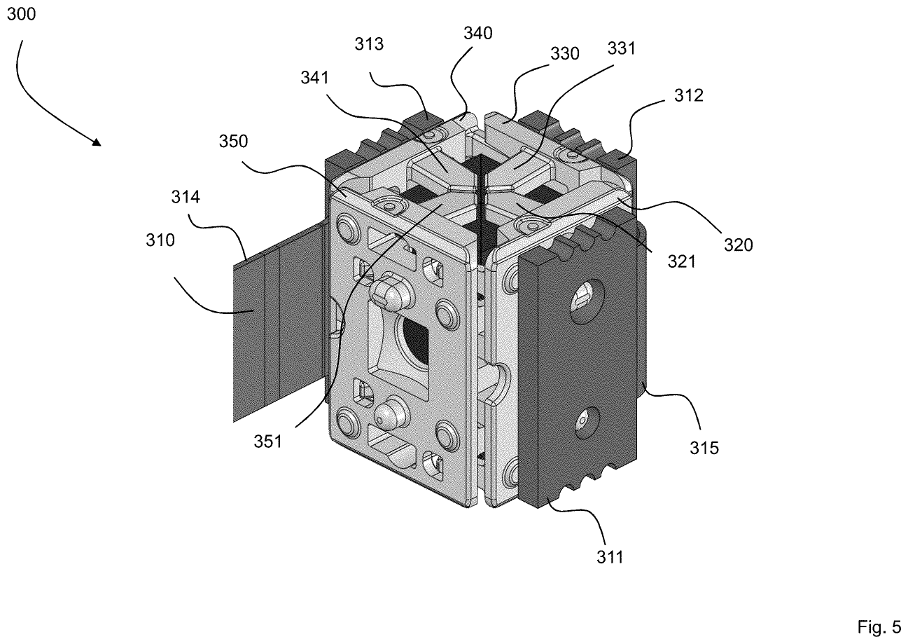

FIG. 5 a further perspective view of an apparatus of FIG. 2;

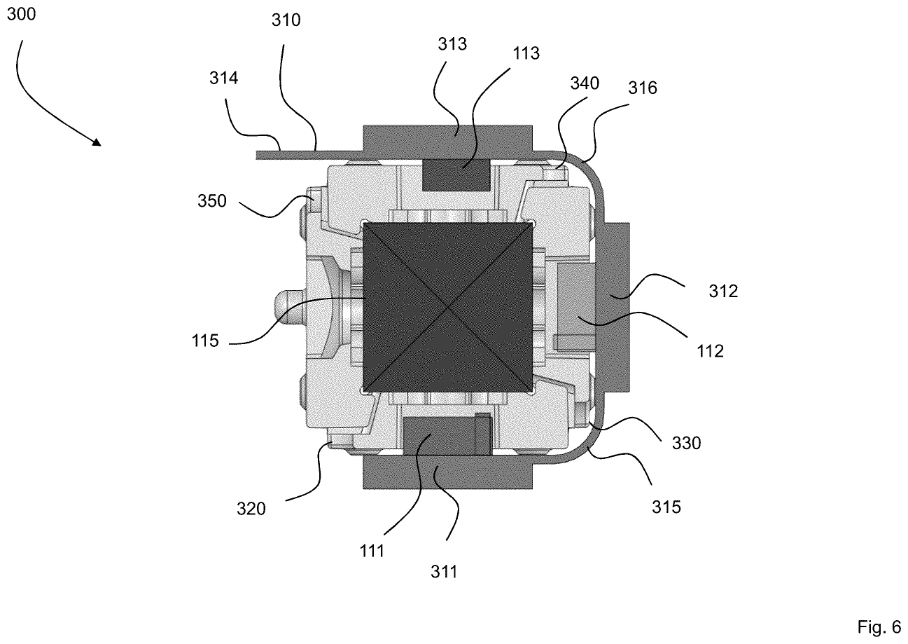

FIG. 6 a plan view of the apparatus shown in FIG. 5 in cross-section;

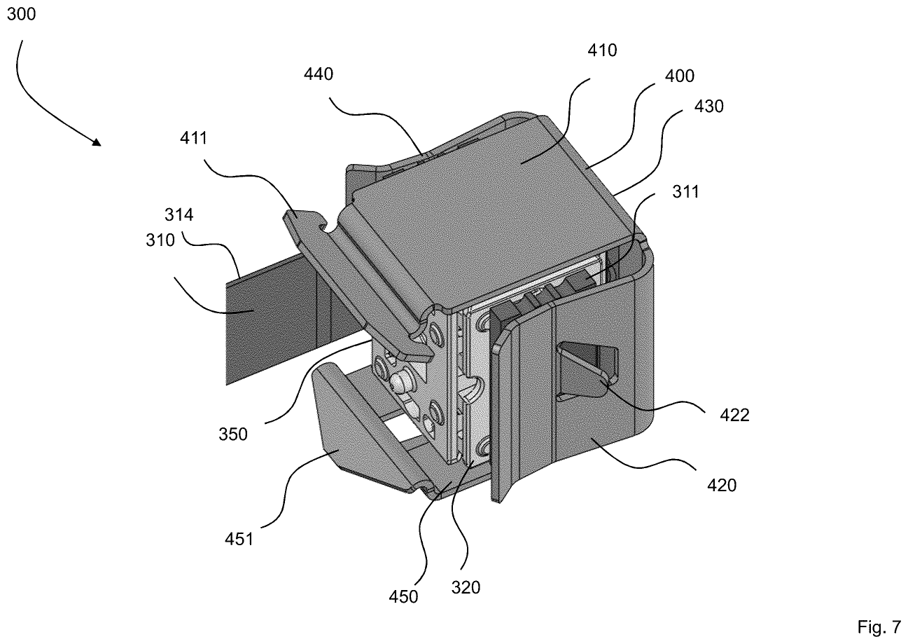

FIG. 7 a further perspective view of an apparatus of FIG. 2;

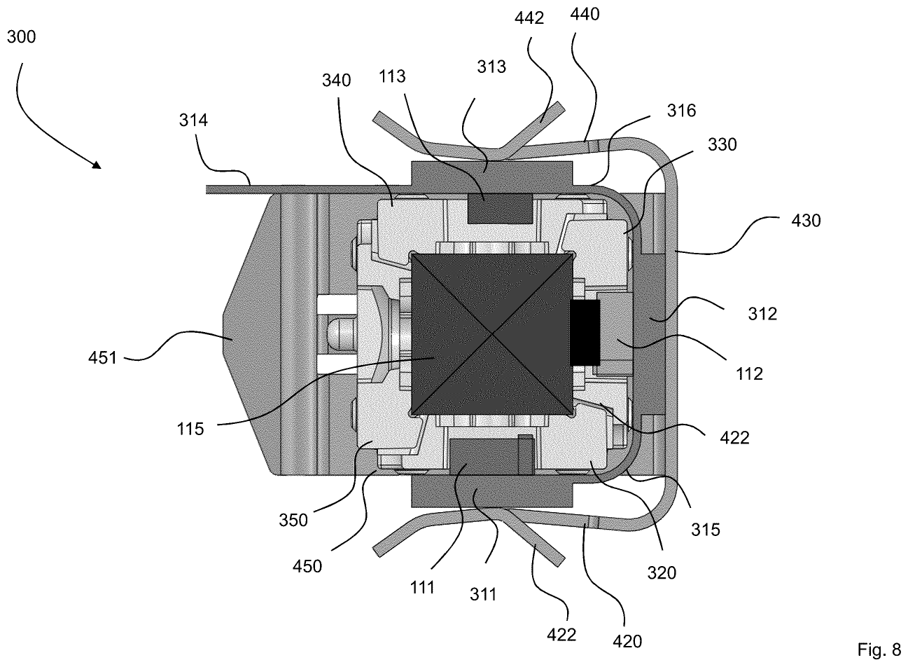

FIG. 8 a plan view of the apparatus shown in FIG. 7 in cross-section;

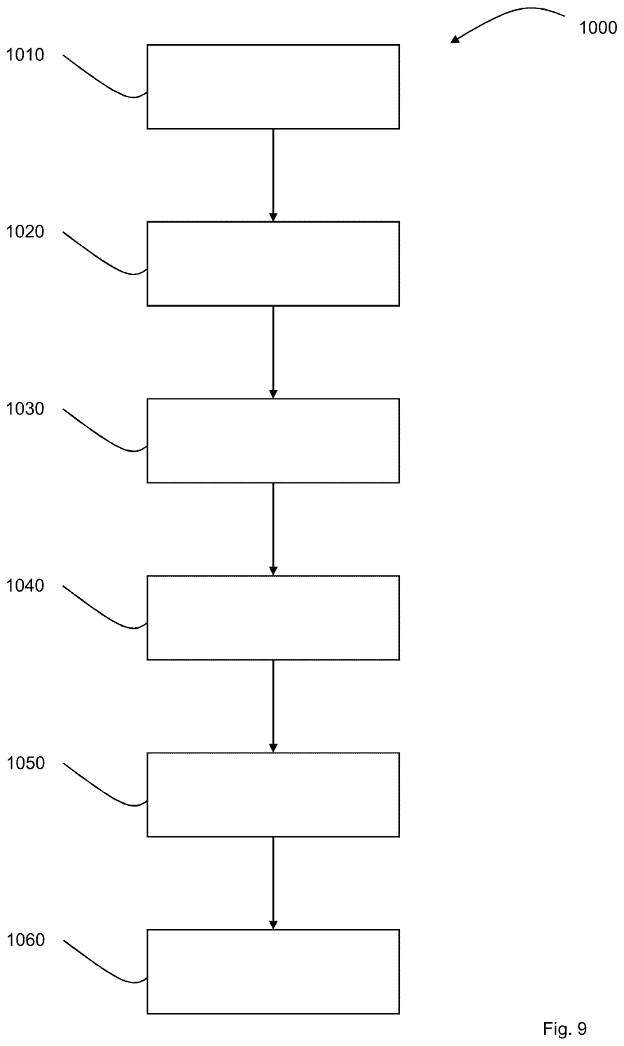

FIG. 9 a flowchart of a method for jointly detecting a color and a distance of an object; and

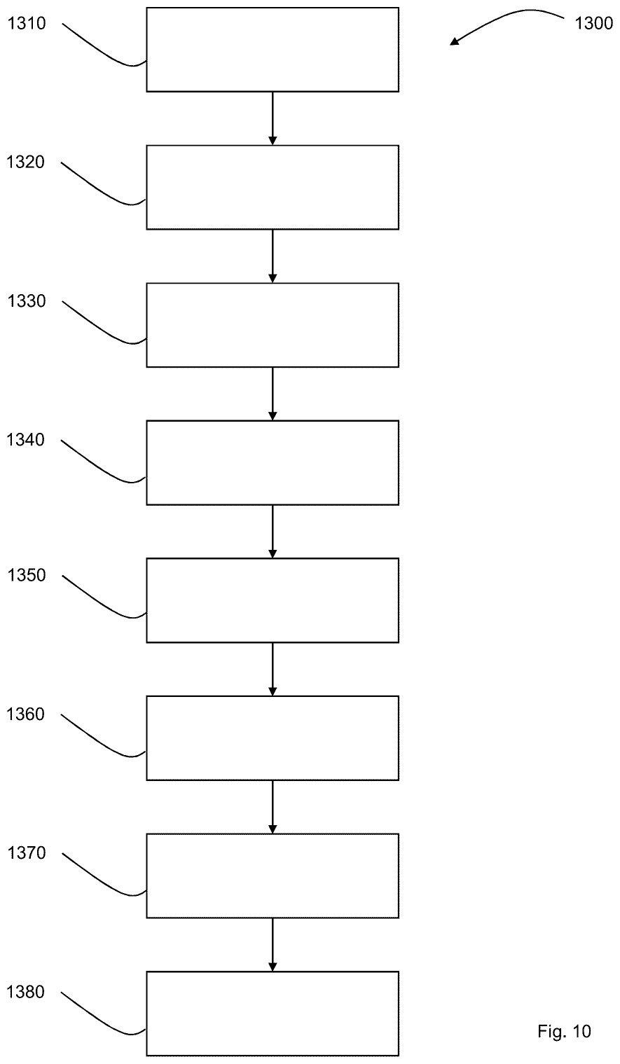

FIG. 10 a flowchart of a method for fastening a superposition optics.

In this respect, identical reference numerals refer to identical or similar features.

FIG. 1 shows a schematic plan view of an apparatus 10 for jointly detecting a color and a distance of an object.

The apparatus 10 has a transmission unit 100, a reception unit 200, and an evaluation unit that is not shown for reasons of clarity.

The transmission unit 100 comprises a light element 110. In this respect, the light element 110 comprises a first light source 111, a second light source 112, and a third light source 113 that are each spaced apart from the other. The first light source 111 is in this respect configured to emit light in a first predefined wavelength range, the second light source 112 is configured to emit light in a second predefined wavelength range, and the third light source 112 is configured to emit light in a third predefined wavelength range. The first wavelength range, the second wavelength range, and the third wavelength range are different in this respect, but can partly overlap.

The transmission unit 100 also comprises a superposition optics that is configured to superpose the light emitted by the three light sources 111, 112, 113 and to direct it to a common beam axis. In this respect, the superposition optics is here shown by way of example as a beam superposition cube 115. The beam superposition cube consists of four prisms that are fastened to one another and that are dichroically coated with one another on the contact surfaces. The beam superposition cube in this respect has four rectangular side surfaces that are of the same size and that are arranged in a rectangular manner with respect to one another as well as a rectangular roof surface and a floor surface that are likewise arranged at right angles to the side surfaces and that either have the same size as the side surfaces or a different size. In the present case, the term cube thus also includes cuboids.

In this respect, the three light sources 111, 112, 113 are arranged around the sides of the beam superposition cube 115 such that a beam direction of the light emitted by the first light source 111 is offset by 90 degrees in the drawing plane from a beam direction of the light emitted by the second light source 112 and a beam direction of the light emitted by the second light source 112 is offset by 90 degrees in the drawing plane from a beam direction of the light emitted by the third light source 113, i.e. the first light source 111 and the third light source 113 are opposed to one another by 180 degrees in the drawing plane. In this respect, the beam superposition cube 115 is arranged and configured in such a manner to direct and to superpose the three beam directions of the three light sources such that a common light beam is emitted opposite to the second light source 112 from the beam superposition cube 115.

The apparatus 10 can in particular also have an apparatus for fastening a superposition optics that is described in more detail in the following FIG. 2.

Other embodiments of a superposition optics, such as a reflector that has a plurality of reflective surfaces or two dichroic mirrors that are likewise configured to superpose the light emitted by the three light sources and to direct it to a common beam axis, which is, however, not shown in the Figures, are equally possible.

The transmission unit 100 also comprises a deflection optics 120 that is configured to deflect the light emitted by the three light sources 111, 112, 113 and superposed by the superposition optics and to redirect it to a transmission optics 130. The transmission optics is in this respect configured to direct the light emitted by the three light sources 111, 112, 113 to an object. The object is not shown for reasons of clarity and is in this respect located to the right of the apparatus 10, outside the drawing area.

The apparatus 10 also comprises a front lens 250 through which the light emitted by the three light sources 111, 112, 113 exits the apparatus, which is shown by the optical path 1. The emitted light is then remitted at the object, which is shown by the optical path 2, and re-enters the apparatus 10 as remitted light through the front lens 250.

There, the remitted light is incident on a reception optics 230 of the reception unit 200 that directs the remitted light to a first reception element 210, on the one hand, and to a second reception element 220, on the other hand, that is spaced apart from the first reception element 210. The first reception element 210 and the second reception element 220 are in this respect configured to receive the light directed to them and to convert it into an electrical signal.

The evaluation unit, not shown, is in this respect configured to evaluate the light received by the first reception element 210 or the electrical signal formed from said light and to determine a distance of the object. The evaluation unit is also configured to evaluate the light received by the second reception element 220 or the electrical signal formed from said light and to determine a color of the object.

Both the transmission unit 100 with all its described components and the reception unit 200 with all its described components are in this respect accommodated in a single housing, not shown for reasons of clarity, that has the front lens 250 as its only optical interface. The evaluation unit can be located either in the housing or outside thereof. The apparatus 10 for jointly detecting a color and a distance of an object in particular uses a single light element 110 comprising three light sources, in particular exactly three light sources, that are used both to determine a color and to determine a distance of the object.

FIG. 2 shows a perspective view of an apparatus 300 that serves to fasten a superposition optics, in particular a superposition optics as shown in FIG. 1. In this respect, as shown in FIG. 2, the apparatus 300 is in a part step of a method for fastening a superposition optics that will be described in detail in connection with FIG. 10.

As initially shown in FIG. 2, the apparatus 300 for fastening a superposition optics comprises a sectionally flexible base element 310, comprising a first rigid section 311, a second rigid section 312, a third rigid section 313, and a fourth rigid section 314.

A first positioning element 320 is arranged at the first rigid section 311, a second positioning element 330 is arranged at the second rigid section 312, and a third positioning element 340 is arranged at the third rigid section 313.

In this respect, the first positioning element 320, the second positioning element 330, and the third positioning element 340 are substantially uniform in shape, wherein each of the positioning elements has a plurality of holding elements and a plurality of locking elements that will be described in the following.

The first positioning element 320 has an upper holding element 321, a lower holding element 324, and four lateral locking elements 322, 323, 325, and 326. Equally, the second positioning element 330 has an upper holding element 331, a lower holding element 334, and four lateral locking elements 332, 333, 335, and 336. The third positioning element 340 also has an upper holding element 341, a lower holding element 344, and four lateral locking elements 342, 343, 345, and 346. In this respect, the two left lateral locking elements 322 and 323, 332 and 333, and 342 and 343 are each arranged offset outwardly from the respective corresponding two right lateral locking elements 325 and 326, 335 and 336, and 345 and 346.

In this respect, the locking elements are arranged such that they can engage with corresponding grooves in the respective adjacent positioning element and can thus fasten the positioning elements to one another.

A light source is centrally arranged in each of the three positioning elements 320, 330, 340, wherein only the first light source 111 in the first positioning element 320 is provided with a reference numeral. Each of the three light sources is in this respect provided with an aperture that is likewise not shown for reasons of clarity.

In this respect, the first positioning element 320, the second positioning element 330, and the third positioning element 340 are fastened to the sectionally flexible base element 310 in the SMD process.

A first flexible section is arranged between the first rigid section 311 and the second rigid section 312 and a second flexible section is arranged between the second rigid section 312 and the third rigid section 313, wherein the rigid sections 315 and 316 are not provided with a reference numeral for reasons of clarity. The base element 310 can also have further flexible sections that are not provided in detail here with reference numerals.

The fourth rigid section 314 furthermore has fastening and/or connection elements for fastening and/or connecting the apparatus 300 to a housing of an apparatus 10 for jointly detecting a color and a distance of an object, as shown in FIG. 1, that are not provided with reference numerals here for reasons of clarity.

FIG. 3 shows a perspective view of an apparatus 300 for fastening a superposition optics as shown in FIG. 2. In this respect, as shown in FIG. 3, the apparatus 300 is in a further part step of a method for fastening a superposition optics, which will be described in detail in connection with FIG. 10.

As can be seen in FIG. 3, a superposition optics has been provided in the form of a beam superposition cube 115, as already described in FIG. 1. As can likewise be seen in FIG. 3, the beam superposition cube 115 has a substantially cuboid shape and is composed of four prisms.

Around the beam superposition cube 115, in this method step shown in this FIG. 3, the three rigid sections 311, 312, 313 with the positioning elements 320, 330, 340 arranged thereat were arranged around the beam superposition cube 115 with the aid of the flexible sections 315 and 316 such that they contact said beam superposition cube 115 at three of the four side surfaces. The flexible sections 315 and 316 are in particular curved such that they form a quarter circle.

As can likewise be seen in this FIG. 3, the upper holding elements 321, 331, and 341 contact the beam superposition cube 115. Equally, the lower holding elements, which are not visible in this FIG. 3 for perspective reasons, contact the beam superposition cube 115 and thus fix it to five of six surfaces.

FIG. 4 shows a plan view of the apparatus 300 shown in FIG. 3 in cross-section. The quarter-circular shape of the flexible sections 315 and 316 can in particular again be seen here.

Equally, it can be seen in FIG. 4 that the beam superposition cube 115 is contacted by the respective positioning elements at three of the four side surfaces and is thus held in position.

The first light source 111, the second light source 112, and the third light source 113 can also be seen in FIG. 4 and can illuminate the three of the four side surfaces with the aid of an aperture.

FIG. 5 shows a perspective view of an apparatus 300 for fastening a superposition optics as shown in FIG. 2 and FIG. 4. In this respect, as shown in FIG. 5, the apparatus 300 is in a further part step of a method for fastening a superposition optics that will be described in detail in connection with FIG. 10.

As can be seen from FIG. 5, a fourth positioning element 350 has been provided that is substantially similar to the other three positioning elements. However, in deviation from the other three positioning elements, no light source is provided in the fourth positioning element 350, but only an aperture that defines a shape and size, for example a diameter, of the common light beam emitted by the beam superposition cube 115.

Equally, it can be seen in FIG. 5 that an upper holding element 351 of the fourth positioning element 350 contacts the beam superposition cube 115 at the upper side and thus fastens it. Similarly, a lower holding element, not shown, contacts the beam superposition cube 115 at the lower side. Also, a further four locking elements of the fourth positioning element 350, which are not shown for perspective reasons, engage with corresponding grooves, likewise not shown, in the adjacent first positioning element 320 and the likewise adjacent third positioning element 340 and thus fasten the beam superposition cube 115 from all six sides.

FIG. 6 shows a plan view of the apparatus 300 shown in FIG. 5.

In this FIG. 6, it can be seen once again that the fourth positioning element 350 does not have a light source, but only an aperture.

FIG. 7 shows a perspective view of an apparatus 300 for fastening a superposition optics as shown in FIG. 2, FIG. 4, and FIG. 6. In this respect, as shown in FIG. 7, the apparatus 300 is in a further part step of a method for fastening a superposition optics that will be described in detail in connection with FIG. 10.

In this respect, the apparatus 300 is introduced into a fastening sleeve 400. The fastening sleeve 400 comprises an upper surface 410, a lower surface 450, and three side surfaces 420, 430, and 440. A fourth side surface is not provided. The apparatus can thus be particularly easily introduced into the fastening sleeve 400.

In this respect, the left and right side surfaces 420 and 440 comprise a fastening element of which only that one of the left side surface is provided with a reference numeral 422. The upper surface 410 and the lower surface 450 each also comprise fastening elements 411 and 451. These fastening elements serve to fasten the apparatus 300 in a housing.

FIG. 8 shows a plan view of the apparatus 300 shown in FIG. 7.

In this respect, the fastening element 442 of the right side surface is in particular also visible.

FIG. 9 shows a flowchart of a method 1000 for jointly detecting a color and a distance of an object.

In this respect, the method 1000 comprises, in a first step 1010, emitting light in a predefined wavelength range. This step can in particular take place by the light element 110 shown in FIG. 1 or the first, second, and third light sources 111, 112 and 113.

In a further step 1020, the method 1000 comprises directing the emitted light to an object. This can in particular take place with the aid of the transmission optics 130 shown in FIG. 1.

In a further step 1030, the method 1000 comprises receiving light that is remitted by the object.

In a further step 1040, the method 1000 comprises directing the remitted light to a first reception element and a second reception element. This can in particular be a first reception element 210 and a second reception element 220, as shown in FIG. 1. This can in particular take place with the aid of the reception optics 230 shown in FIG. 1.

In a further step 1050, the method 1000 comprises evaluating the light received by the first reception element to determine a distance of the object.

In a further step 1060, the method 1000 comprises evaluating the light received by the second reception element to determine a color of the object.

The method steps described, in particular steps 1050 and 1060, can in this respect be carried out simultaneously.

In a further step, which is not shown in FIG. 9 and which can in particular take place before the first step 1010, an apparatus for jointly detecting a color and a distance of an object, in particular as described in connection with FIGS. 1 to 8, is provided and/or the method 1000 is carried out by said apparatus.

FIG. 10 shows a flowchart of a method 1300 for fastening a superposition optics, in particular a superposition optics as described in connection with FIGS. 1 to 8.

In a first step 1310, an apparatus for fastening a superposition optics is provided, comprising a sectionally flexible base element and a first, second, and third positioning element arranged thereat, in particular an apparatus for fastening a superposition optics as shown in FIG. 2.

In a following step 1320, the sectionally flexible base element is bent and the first positioning element is brought into engagement with the second positioning element and the second positioning element is brought into engagement with the third positioning element.

In a further step 1330, a superposition optics is provided.

In a further step 1340, the superposition optics is arranged within a hollow space that is created by the engagement of the first, second, and third positioning elements, in particular as shown in FIGS. 3 and 4.

In a further step 1350, a fourth positioning element is provided.

In a subsequent step 1360, the fourth positioning element is brought into engagement with the first and third positioning elements and thus fastens the superposition optics, in particular as shown in FIGS. 5 and 6.

In a further step 1370, a fastening sleeve is provided.

In a subsequent step 1380, the fastening sleeve is fastened to the sectionally flexible base element, as shown in FIGS. 7 and 8.

In an optional step, not shown, the fastening sleeve can be fastened to a housing, in particular to a housing of an apparatus for jointly detecting a color and a distance of an object, as shown in FIG. 1.

### REFERENCE NUMERAL LIST

10 apparatus
100 transmission unit
110 light element
111 first light source
112 second light source
113 third light source
115 beam superposition cube
120 deflection optics
130 transmission optics
200 reception unit
210 first reception element
220 second reception element
230 reception optics
250 front lens
300 apparatus
310 base element
311 first rigid section
312 second rigid section
313 third rigid section
314 fourth rigid section
315 first flexible section
316 second flexible section
320 first positioning element
321 upper holding element
322 locking element
323 locking element
324 lower holding element
325 locking element
326 locking element
330 second positioning element
331 upper holding element
332 locking element
333 locking element
334 lower holding element
335 locking element
336 locking element
340 third positioning element
341 upper holding element
342 locking element
343 locking element
344 lower holding element
345 locking element
346 locking element
350 fourth positioning element
351 upper holding element
400 fastening sleeve
410 upper surface
411 fastening element
420 side surface
422 fastening element
430 side surface
440 side surface
442 fastening element
450 lower surface
451 fastening element
1000 method
1010 method step
1020 method step
1030 method step
1040 method step
1050 method step
1060 method step
1300 method step
1310 method step
1320 method step
1330 method step
1340 method step
1350 method step
1360 method step
1370 method step
1380 method step

1. An apparatus for jointly detecting a color and a distance of an object, said apparatus comprising:
a transmission unit, comprising:
a light element that is configured to emit light in a predefined wavelength range; and
a transmission optics that is configured to direct the emitted light to an object;
a reception unit, comprising
a first reception element;
a second reception element that is arranged spaced apart from the first reception element; and
a reception optics,
wherein the reception optics is configured to receive light remitted by the object and to direct it to the first reception element and the second reception element; and
an evaluation unit that is configured to evaluate light received by the first reception element and to determine a distance of the object and to evaluate light received by the second reception element and to determine a color of the object.

2. The apparatus in accordance with claim 1,
wherein the light element has a first light source, a second light source, and a third light source that are spaced apart from one another and that are configured to emit light in three different predefined wavelength ranges,
wherein the transmission unit further has a superposition optics that is configured to superpose the light emitted by the three light sources and to direct it to a common beam axis.

3. The apparatus in accordance with claim 2,
wherein the superposition optics comprises a reflector that has a plurality of reflective surfaces that are arranged and configured to superpose the light emitted by the three light sources and to direct it to a common beam axis.

4. The apparatus in accordance with claim 2,
wherein the superposition optics has one mirror and two dichroic mirrors that are arranged and configured to superpose the light emitted by the three light sources and to direct it to a common beam axis.

5. The apparatus in accordance with claim 2,
wherein the superposition optics comprises a first prism, a second prism, a third prism, and a fourth prism that are arranged adjacent to one another such that they together have a cuboid shape, wherein contact surfaces between the prisms are dichroically coated and are arranged and configured to superpose the light emitted by the three light sources and to direct it to a common beam axis.

6. The apparatus in accordance with claim 5,
further comprising a sectionally flexible base element at which the first light source, the second light source, and the third light source are arranged, wherein the base element is arranged around the superposition optics such that one light source each is arranged at one of three adjacent side surfaces of the superposition optics.

7. The apparatus in accordance with claim 6,
wherein the base element has a first positioning element, a second positioning element, and a third positioning element that fasten the first light source, the second light source, and the third light source at a predefined distance from the three adjacent side surfaces of the superposition optics.

8. The apparatus in accordance with claim 7,
wherein the base element further has a fourth positioning element, and wherein the first positioning element, the second positioning element, the third positioning element, and the fourth positioning element fasten the superposition optics to four adjacent side surfaces.

9. The apparatus in accordance with claim 8,
wherein the fourth positioning element has an aperture that is configured to spatially limit the light superposed by the superposition optics.

10. The apparatus in accordance with claim 9,
wherein the fourth positioning element fastens the aperture at a predefined distance from the fourth side surface.

11. The apparatus in accordance with claim 7,
wherein the first positioning element, the second positioning element, and the third positioning element each comprise an upper and a lower holding element that are configured to fasten the superposition optics to an upper surface and a lower surface.

12. The apparatus in accordance with claim 1,
wherein the evaluation unit is configured to correct the determined color based on the determined distance of the object.

13. The apparatus in accordance with claim 1,
wherein the reception optics is formed in one piece.

14. A method for jointly detecting a color and a distance of an object, comprising:
emitting light in a predefined wavelength range;
directing the emitted light to an object;
receiving light remitted by the object;
directing the remitted light to a first reception element and a second reception element;
evaluating the light received by the first reception element to determine a distance of the object; and
evaluating the light received by the second reception element to determine a color of the object.
